(19) United States
(12) Patent Application Publication
(10) Pub. No.: US 2013/0058206 A1
(43) Pub. Date: Mar. 7, 2013

(54) SLOTTING OF LAST GASP COMMUNICATIONS

(71) Applicants: William E. San Filippo, III, Los Altos Hills, CA (US); Jana Van Greunen, Redwood City, CA (US)

(72) Inventors: William E. San Filippo, III, Los Altos Hills, CA (US); Jana Van Greunen, Redwood City, CA (US)

(21) Appl. No.: 13/226,658

(22) Filed: Sep. 7, 2011

(51) Int. Cl. G06F 11/00

(52) U.S. Cl. 370/216

(57) ABSTRACT

A commodity delivery system. The system includes a plurality of commodity delivery devices. The plurality of commodity delivery devices are configured to at least one of transport the commodity, modify the commodity, and monitor the commodity. A subset of the plurality of commodity delivery devices is further configured to receive a beacon from a network device, designate a plurality of transmission time slots based on the beacon, the transmission time slots synchronized for all of the plurality of commodity delivery devices, detect an error condition, select a transmission time slot following the detection of the error condition, and transmit a last gasp message during the selected transmission time slot.

### BACKGROUND

The invention relates to power outage reporting (last gasp) by devices on a commodity delivery network. Specifically, the invention relates to slotting of last gasp communication messages to reduce collisions between communications from multiple devices.

Many modern commodity delivery networks (e.g., electric, gas, etc.) include smart devices along the delivery pathway. These smart devices monitor various aspects of the commodity (e.g., usage) and include communication capabilities to report back to the commodity provider.

### SUMMARY

In one embodiment, the invention provides a commodity delivery system. The system includes a plurality of commodity delivery devices. The plurality of commodity delivery devices are configured to at least one of transport the commodity, modify the commodity, and monitor the commodity. A subset of the plurality of commodity delivery devices is further configured to receive a beacon from a network device, designate a plurality of transmission time slots based on the beacon, the transmission time slots synchronized for all of the plurality of commodity delivery devices, detect an error condition, select a transmission time slot following the detection of the error condition, and transmit a last gasp message during the selected transmission time slot.

In another embodiment the invention provides a method of informing a commodity provider of an interruption in the delivery of the commodity. The method includes receiving a beacon by a first commodity delivery device, designating, by the first commodity delivery device, a plurality of transmission time slots based on the beacon, detecting an interruption in delivery of the commodity, selecting a transmission time slot following the detection of the interruption in the delivery of the commodity, and transmitting a last gasp message during the selected transmission time slot.

In another embodiment the invention provides a commodity delivery device. The device includes a communication circuit, a commodity monitoring circuit, and a controller. The communication circuit is configured to transmit and receive messages. The commodity monitoring circuit is configured to detect an interruption in delivery of the commodity. The controller is configured to receive an indication of the interruption in delivery of the commodity from the commodity monitoring circuit, detect a beacon received by the communication circuit, designate a plurality of transmission time slots based on the beacon, randomly select one of the plurality of transmission time slots, and transmit via the communication circuit a last gasp message in the selected one of the plurality of transmission time slots when the indication of the interruption in delivery of the commodity is received

Other aspects of the invention will become apparent by consideration of the detailed description and accompanying drawings.

### BRIEF DESCRIPTION OF THE DRAWINGS

FIG. 1 is a diagram of a commodity delivery network.

FIG. 2 is a diagram of a communication network overlaid on the commodity delivery network of FIG. 1.

FIG. 3 is a time line of a prior art last gasp communication scheme.

FIG. 4 is flow chart of an exemplary process for communicating last gasp messages that reduces the probability of a collision between communications from multiple commodity delivery devices.

FIG. 5 is a time line of last gasp communication messages transmitted using the process of FIG. 4.

FIG. 6 is a block diagram of a commodity delivery device for executing the process of FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

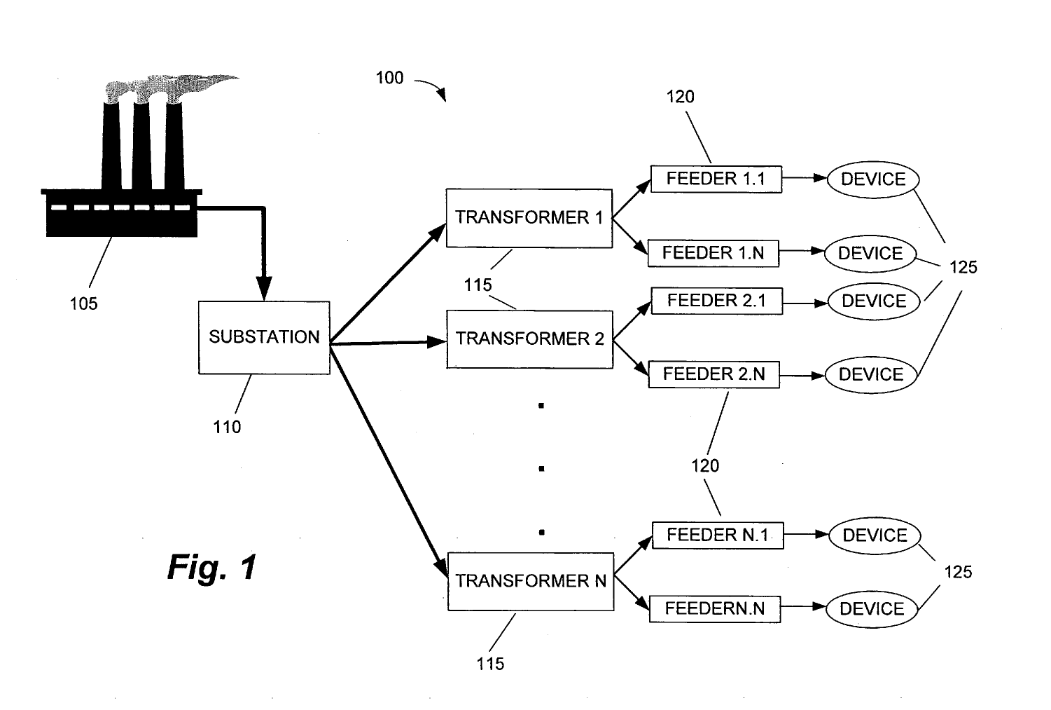

FIG. 1 shows an exemplary commodity delivery network 100. The commodity delivery network 100 in this example is for delivering electricity to end-users (e.g., homes, businesses, etc.). The delivery network 100 includes a power generation plant 105, a plurality of substations 110 which receive high-voltage power from the power generation plant 105, a plurality of transformers 115, a plurality of feeders or laterals 120, and a plurality of end-devices 125 (e.g., a smart electric meter). The power generation plant 105 generates electricity and provides high-voltage power to the substations 110. The substations 110 step down the voltage they receive from the power generation plant 105, and supply the stepped-down voltage to the transformers 115. The transformers 115 again step down the voltage and supply this voltage, via the feeders/laterals 120, to end-users (e.g., residential buildings) through the end-devices 125. The end-devices 125 monitor, and in some cases control, usage of the commodity by the end-users.

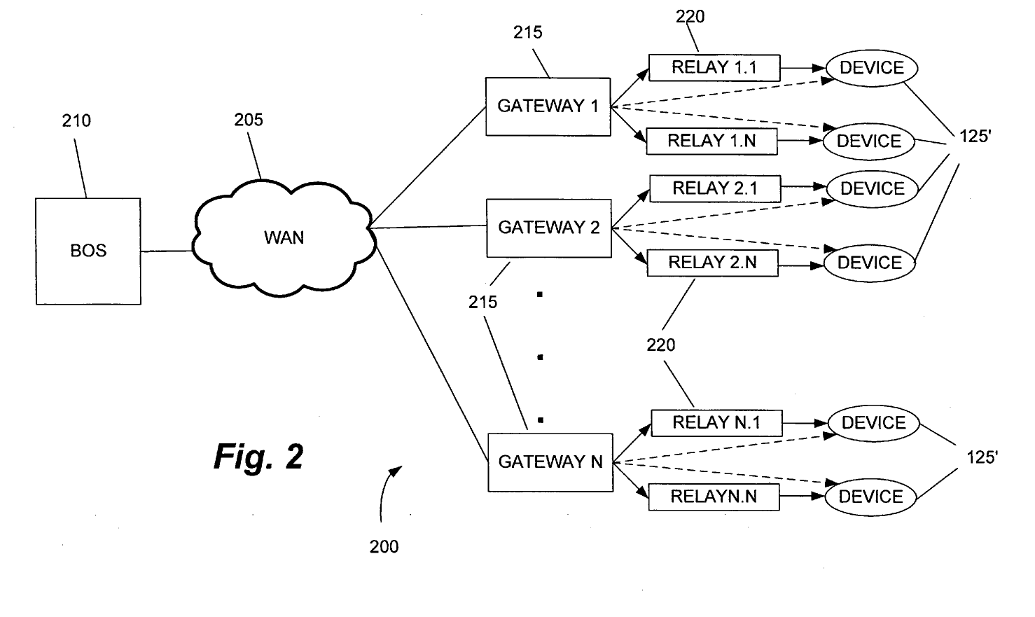

FIG. 2 shows an exemplary construction of the communication network 200 which overlays the delivery network 100. The communication network 200 enables communication between the utility provider (e.g., the power generation plant 105) and the components (e.g., the plurality of substations 110, the plurality of transformers 115, the plurality of feeders or laterals 120, and the plurality of end-devices 125) of the delivery network 100. The communication network 200 includes a wide-area-network (WAN) 205 via which a back office 210 of the utility provider communicates with a local-area-network (LAN). The LAN includes a plurality of gateways 215, a plurality of relays 220, and a plurality of end-devices 125′. The components of the delivery network 100 can perform one or more of the communication network 200 functions (e.g., the gateway 215, the relay 220, and the end-device 125′ functions), or they can perform none of the communication network 200 functions. In addition, one or more of the gateways 215 and/or relays 220 can be communication network only devices. That is, they perform communication network functions but do not perform any commodity delivery functions.

U.S. Pat. No. 7,853,417 filed on May 17, 2007, and entitled “Methods and System for Utility Network Outage Detection,” the entire content of which is hereby incorporated by reference, describes the operation of the communication network 200 in greater detail. In addition, the invention can be practiced using other communication network constructions. For example, U.S. patent application Ser. No. 12/510,168 filed on Jul. 27, 2009, and entitled “Meshed Networking of Access Points in a Utility Network,” and U.S. patent application Ser. No. 12/167,592 filed on Jul. 3, 2008, and entitled “Network Utilities in Wireless Mesh Communications Networks,” the entire content of each is hereby incorporated by reference, disclose mesh communication networks for use in utility distribution systems.

When power to an end-device 125 (or other distribution device) is interrupted (e.g., due to a power outage or a downed power line supplying the end-device 125), the end-device 125 quickly detects the interruption. In order to assist the utility provider in determining an extent of a power outage, the end-device 125 sends out a “last gasp” message indicating that it has lost power. Some end-devices 125 have an internal power source (e.g., a battery backup); however, the majority of end-devices 125 do not have an internal power source. The end-devices 125 without an internal power source maintain (e.g., via a capacitor) operational power for only a short period of time (e.g., several hundred milliseconds) following the power interruption. Accordingly, the end-devices 125 have only a short window of opportunity to transmit the last gasp message before their operational power is too low to function.

In the event of a power outage affecting more than a single end-device 125 (e.g., a downed power line, a blown transformer 115, a substation 110 failure, etc.), hundreds or thousands of end-devices 125 (or transmission devices such as transformers 115 and laterals 120) detect the outage nearly simultaneously. The end-devices 125 attempt to send last gasp messages to inform the utility provider of the outage. Last gasp messages are very short (e.g., only containing information identifying the sending device 125 and that the message is a last gasp), taking only a couple of milliseconds to transmit. However, when a large number of devices 125 detect the outage at virtually the same time, and send their last gasp messages at virtually the same time, messages from multiple devices “collide” causing the messages to be lost. Therefore, prior art networks have used a slotting method of communication to improve the number of messages that do not collide with other messages and get through to a self-powered relay 210 or gateway 215.

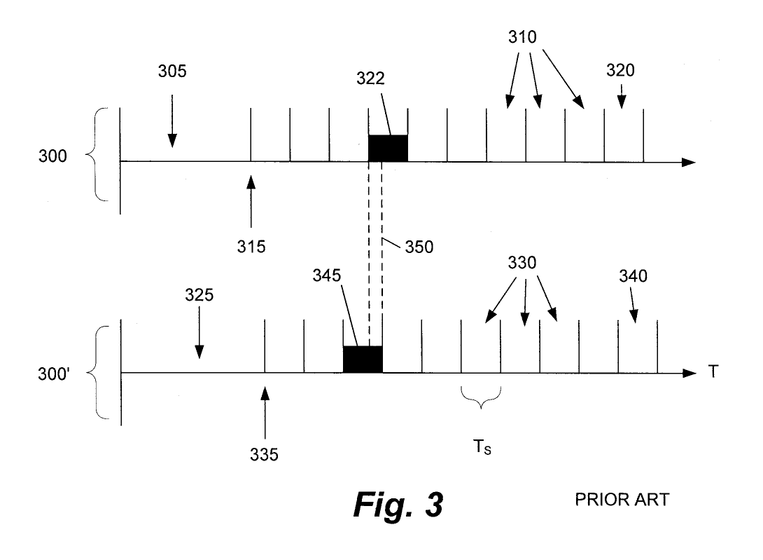

FIG. 3 shows a time line 300 demonstrating a prior art slotting method for an end-device 125″. At time 305 the end-device 125″ detects a power interruption. The device 125″ then designates a plurality of time slots 310 beginning at time 315 with the last time slot 320 occurring prior to the time at which the device 125″ will no longer maintain power to transmit its last gasp message. Each time slot 310 has a duration Tₛ which is essentially equivalent, but slightly longer, than the time needed to transmit the last gasp message. The device 125″ then randomly chooses one of the time slots 322, and transmits its last gasp message during the time slot 322.

FIG. 3 also shows a time line 300′ demonstrating the prior art slotting method for a second end-device 125′″. At time 325 the end-device 125′″ detects a power interruption. The device 125′ then designates a plurality of time slots 330 beginning at time 335 with the last time slot 340 occurring prior to the time at which the device 125′″ will no longer maintain power to transmit its last gasp message. Each time slot 330 has a duration Tₛ which is essentially equivalent, but slightly longer, than the time needed to transmit the last gasp message. The device 125′″ then randomly chooses one of the time slots 345, and transmits its last gasp message during the time slot 345.

By slotting the last gasp transmissions, the number of collisions and lost messages are greatly reduced. However, as shown in FIG. 3, because the end-devices 125″ and 125′″ detect the outage at different points in time, 305 vs. 325, the plurality of slots 310 designated by device 125″ overlap 350 the plurality of slots 330 designated by the other device 125′″. Therefore, even though two devices 125″ and 125′″ choose different slots 322 and 345, the overlap 350 causes both of their last gasp transmissions to be lost. The chance (probability) of a collision using this slotting method has been shown to be equal to e^{-2G} (i.e., ALOHA protocol). Where G equals the load on a given channel.

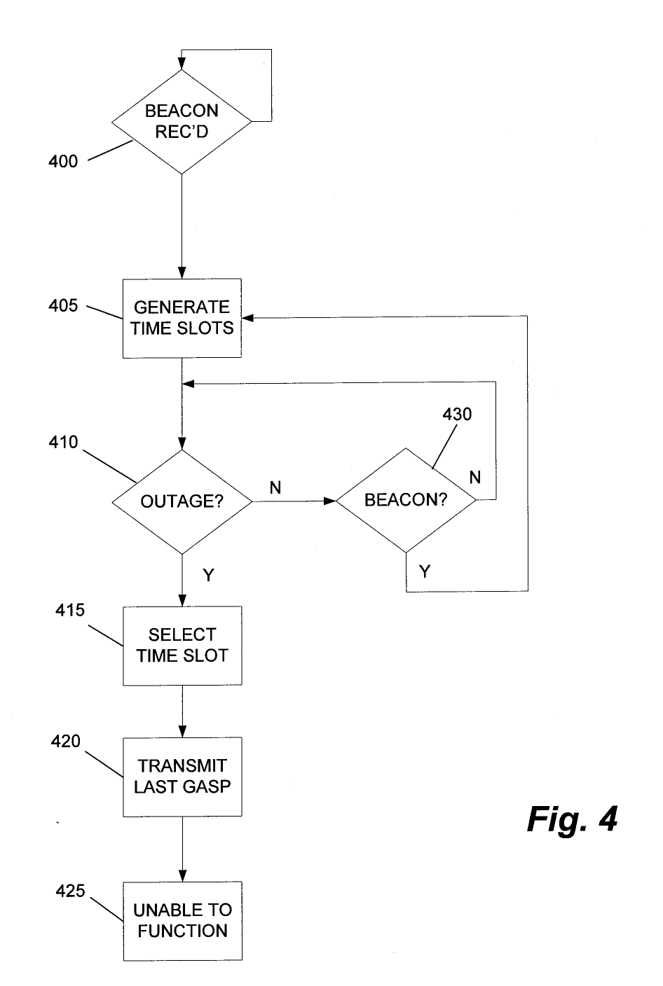

FIG. 4 shows a process by which the probability of a collision is significantly reduced through synchronization of time slots using a beacon signal. On power up, the end-device 125 waits to receive a beacon signal (step 400). The gateway 215 transmits the beacon signal which is received by a plurality of end-devices geographically near the gateway 215. In some embodiments, the beacon signal is cyclically transmitted following a predetermined time period (e.g., once every five seconds). In other embodiments, the beacon signal is transmitted during periods when there is no other communication taking place. In some embodiments, the beacon signal is generated by a device external to the communication network 200 (e.g., an atomic clock).

Once the end-device 125 receives the beacon signal, the end-device 125 generates a plurality of time slots starting at a predetermined time following receipt of the beacon signal (step 405). Because each end-device 125 receives the beacon signal at the same time, all of the end-devices 125 generate essentially the same time slots. Should an error (e.g., a power outage) occur (step 410), the end-device 125 randomly selects a time slot (step 415) and transmits a last gasp message (step 420) before losing power (step 425). If an error did not occur (step 410), the end-device 125 checks for another beacon signal (step 430). If a new beacon signal is received, the end-device continues by generating a new plurality of time slots (step 405). If a new beacon signal is not received, the end-device again checks for an error (step 410).

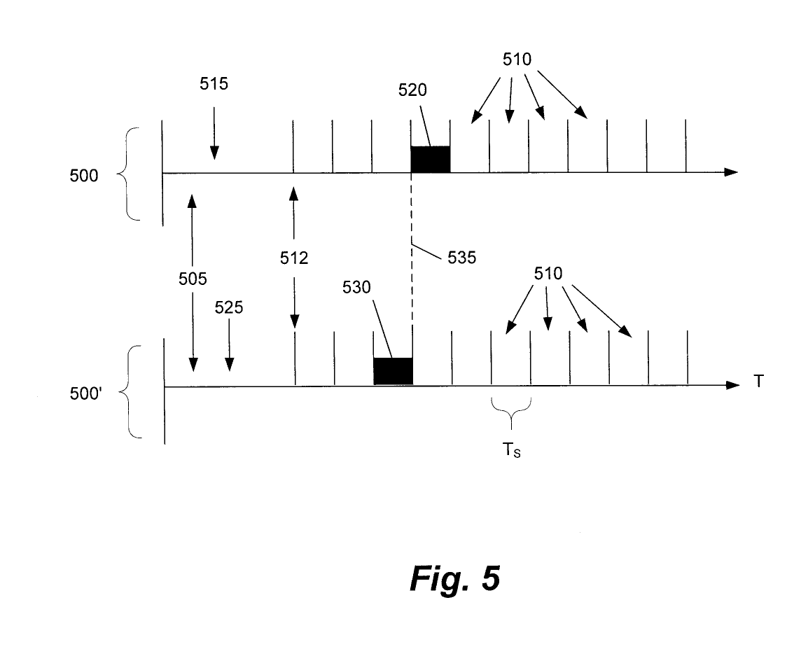

FIG. 5 shows time lines 500 and 500′ (for end-devices 125″ and 125′″ respectively) illustrating the process of FIG. 4. Each end-device 125″ and 125′″ receives a beacon signal at time 505. The end-devices 125″ and 125′″ generate a plurality of time slots 510 starting at time 512. The time slots 510 are synchronized (i.e., start and end at the same time) for both devices 125″ and 125′″. Device 125″ detects a power interruption at time 515, and randomly selects to transmit its last gasp message in the fourth time slot 520. Device 125′″ detects a power interruption at time 525 which is slightly later than the interruption is detected by device 125″. Device 125′″ randomly selects to transmit its last gasp message in the third time slot 530. Because the time slots are synchronized, based on receipt of the beacon signal, the last gasp transmission from device 125″ ends at time 535 and the last gasp transmission from device 125′″ starts at time 535. Because the time slots 510 are synchronized, they do not overlap and the messages do not collide with one another.

Synchronizing the time slots for all devices in an area improves the probability of a transmission not colliding with a transmission from another device. The probability can be determined using the formula e^{-G} (i.e., slotted ALOHA protocol).

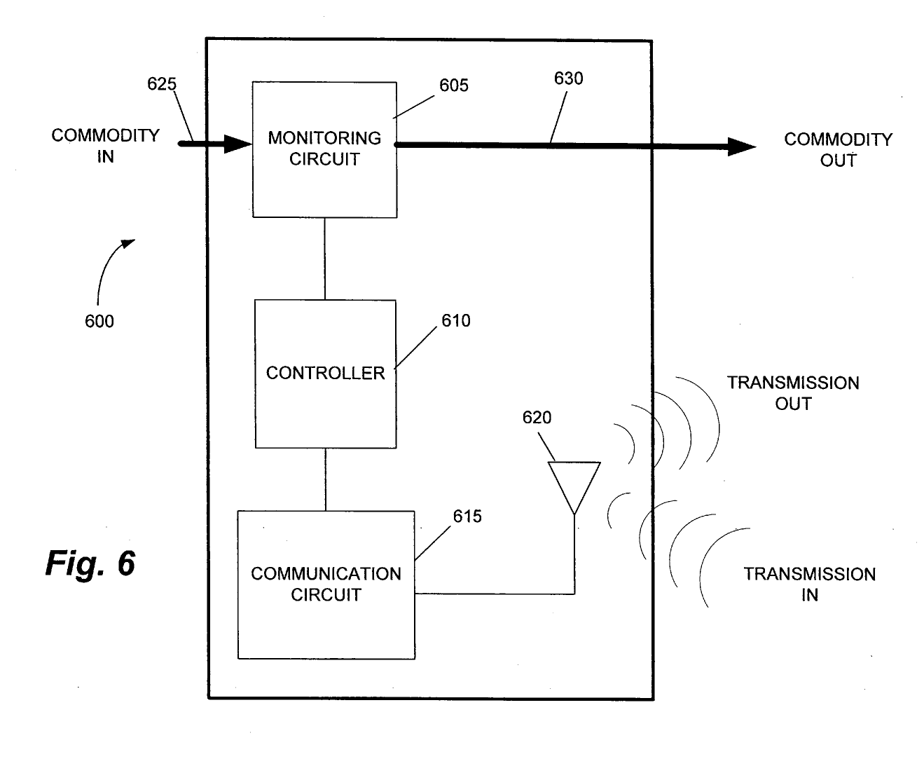

FIG. 6 shows an embodiment of a commodity delivery device 600 for performing the processes described above. The device 600 includes a monitoring circuit 605, a controller 610, a communication circuit 615, and an antenna 620. The monitoring circuit 605 is coupled to a commodity delivery conduit 625, and monitors one or more parameters of the commodity. In some embodiments, the monitoring circuit 605 passes the commodity to an output conduit 630. In other embodiments, the commodity delivery conduit 625 and the output conduit 630 are the same conduit. The monitoring circuit 605 provides an indication of the one or more parameters monitored to the controller 610.

The controller 610 can provide information on the one or more parameters monitored to the communication circuit 615 for transmission to another device (e.g., the back office system 210). The controller 610 can also receive communications (e.g., polling requests, beacon signals, etc.) from other devices (e.g., a gateway 215) via the communication circuit 615.

Various features and advantages of the invention are set forth in the following claims.

What is claimed is:

1. A commodity delivery system, comprising:
a plurality of commodity delivery devices configured to at least one of transport the commodity, modify the commodity, and monitor the commodity;
a subset of the plurality of commodity delivery devices further configured to receive a beacon from a network device,
designate a plurality of transmission time slots based on the beacon, the transmission time slots synchronized for all of the plurality of commodity delivery devices,
detect an error condition,
select a transmission time slot following the detection of the error condition, and
transmit a last gasp message during the selected transmission time slot.

2. The system of claim 1, wherein the network device includes an internal power source.

3. The system of claim 1, wherein the network device receives last gasp messages from the subset of the plurality of commodity delivery devices.

4. The system of claim 3, wherein the network device forwards the received last gasp messages to a back office system.

5. The system of claim 3, wherein the network device consolidates the received last gasp messages and sends a message to a back office system indicating from which of the plurality of commodity delivery devices a last gasp message was received.

6. The system of claim 3, wherein the back office system determines an extent of the error condition based on the plurality of devices from which last gasp messages were received.

7. The system of claim 1, wherein the timeslot is randomly selected.

8. The system of claim 1, wherein the designated transmission timeslots occur before the subset of the plurality of devices loses operational power.

9. The system of claim 1, wherein the network device is one of the plurality of commodity delivery devices.

10. The system of claim 1, wherein the error condition is an interruption in the delivery of the commodity.

11. A method of informing a commodity provider of an interruption in the delivery of the commodity, the method comprising:
receiving a beacon by a first commodity delivery device;
designating, by the first commodity delivery device, a plurality of transmission time slots based on the beacon;
detecting an interruption in delivery of the commodity;
selecting a transmission time slot following the detection of the interruption in the delivery of the commodity; and
transmitting a last gasp message during the selected transmission time slot.

12. The method of claim 11, further comprising sending the beacon by a second commodity delivery device.

13. The method of claim 12, wherein the second commodity delivery device includes an internal power source.

14. The method of claim 12, wherein the second commodity delivery device receives a last gasp message from the first commodity delivery device.

15. The method of claim 14, further comprising forwarding the received last gasp message to a back office system.

16. The method of claim 15, further comprising consolidating the received last gasp message with last gasp messages received from other commodity delivery devices, and sending a message to a back office system indicating from which commodity delivery devices a last gasp message was received.

17. The method of claim 14, further comprising determining by the back office system an extent of the interruption of the delivery of the commodity based the last gasp messages received.

18. The method of claim 11, wherein the transmission time slots are synchronized with transmission time slots for a plurality of commodity delivery devices receiving the beacon

19. A commodity delivery device, the device comprising:
a communication circuit configured to transmit and receive messages;
a commodity monitoring circuit configured to detect an interruption in delivery of the commodity; and
a controller configured to
receive an indication of the interruption in delivery of the commodity from the commodity monitoring circuit,
detect a beacon received by the communication circuit,
designate a plurality of transmission time slots based on the beacon,
randomly select one of the plurality of transmission time slots, and
transmit via the communication circuit a last gasp message in the selected one of the plurality of transmission time slots when the indication of the interruption in delivery of the commodity is received.

20. The commodity delivery device of claim 19, wherein the commodity monitoring circuit is configured to monitor one or more parameters of the commodity.

21. The commodity delivery device of claim 20, wherein the commodity monitoring circuit is configured to provide an indication of the monitored parameters to the controller, and the controller is configured to communicate the monitored parameters to a back office system via the communication circuit.
